(19) United States
(12) Patent Application Publication
(10) Pub. No.: US 2024/0101730 A1
(43) Pub. Date: Mar. 28, 2024

(54) SLIDING MEMBER AND SLIDING BODY

(71) Applicant: TAIHO KOGYO CO., LTD., Toyota-shi (JP)

(72) Inventors: Masaki MURAI, Aichi (JP); Masaya TOKORO, Aichi (JP); Naoki HORIBE, Aichi (JP)

(73) Assignee: TAIHO KOGYO CO., LTD., Toyota-shi (JP)

(21) Appl. No.: 18/470,888

(22) Filed: Sep. 20, 2023

(30) Foreign Application Priority Data
Sep. 28, 2022 (JP) 2022-155568

(51) Int. Cl. C08F 14/26; C08K 3/04; C08K 3/30; C08K 3/32; C08K 3/34; C08K 3/40

(52) U.S. Cl. CPC C08F 14/26; C08K 3/042; C08K 3/046; C08K 3/30; C08K 3/32; C08K 3/346; C08K 3/40; C08K 2003/3009; C08K 2003/3045; C08K 2003/326

(57) ABSTRACT

A sliding member is formed of a polytetrafluoroethylene resin. The polytetrafluoroethylene resin contains 2.4 wt % or more and 15.6 wt % or less magnesium phosphate, 7.6 wt % or more and 19.9 wt % or less barium sulfate, 0 wt % or more and 10.0 wt % or less molybdenum disulfide, and 8.3 wt % or more and 15.7 wt % or less fired clay.

### CROSS-REFERENCE TO RELATED APPLICATIONS

This application is based upon and claims the benefit of priority from Japanese Patent Application No. 2022-155568, filed Sep. 28, 2022, the entire contents of which are incorporated herein by reference.

### FIELD

The present invention relates to a sliding member and a sliding body.

### BACKGROUND

A technique of using, as a sliding member, a resin layer containing polytetrafluoroethylene (PTFE) as a main component from the viewpoint of improving wear resistance and the like has been heretofore disclosed. In addition, a technique of using PTFE while adding an additive thereto in accordance with use of a sliding member or the like is disclosed. The related techniques are described in JP 2002-20568 A and JP H08-41484 A.

However, in the conventional technology, in a case where a surface of a counter member such as a shaft member is rough, the amount of wear of the sliding member may be large, and wear resistance may not be obtained.

An object of the present invention is to provide a sliding member and a sliding body capable of improving wear resistance.

### SUMMARY

A sliding member according to an aspect of the present invention is formed of a polytetrafluoroethylene resin. The polytetrafluoroethylene resin contains 2.4 wt % or more and 15.6 wt % or less magnesium phosphate, 7.6 wt % or more and 19.9 wt % or less barium sulfate, 0 wt % or more and 10.0 wt % or less molybdenum disulfide, and 8.3 wt % or more and 15.7 wt % or less fired clay.

According to an aspect of the present invention, wear resistance can be improved.

### BRIEF DESCRIPTION OF THE DRAWINGS

FIG. 1 is a schematic view illustrating an example of a sliding body of an embodiment;

FIG. 2A is an explanatory view of an example of an action of a sliding member;

FIG. 2B is an explanatory view of an example of an action of a sliding member;

FIG. 3A is a schematic view illustrating an example of a form of applying the sliding body;

FIG. 3B is a schematic view illustrating an example of a form of applying the sliding body;

FIG. 4A is an explanatory view of an evaluation test of wear resistance;

FIG. 4B is an explanatory view of an evaluation test of wear resistance;

FIG. 4C is an explanatory view of an evaluation test of wear resistance; and

FIG. 4D is an explanatory view of an evaluation test of wear resistance.

### DETAILED DESCRIPTION

Hereinafter, embodiments of a sliding member and a sliding body according to the present invention will be described in detail with reference to the accompanying drawings.

The sliding member of the present embodiment is formed of a polytetrafluoroethylene resin (hereinafter, referred to as PTFE) containing 2.4 wt % or more and 15.6 wt % or less magnesium phosphate, 7.6 wt % or more and 19.9 wt % or less barium sulfate, 0 wt % or more and 10.0 wt % or less molybdenum disulfide, and 8.3 wt % or more and 15.7 wt % or less fired clay.

Therefore, the sliding member of the present embodiment can improve wear resistance.

The reason that the above effect is exhibited is not clear, but is presumed as follows. However, the present invention is not limited by the following presumption.

In the sliding member of the present embodiment, PTFE as a main component of the sliding member contains the fired clay, magnesium phosphate, barium sulfate, and molybdenum disulfide with the contents described above. In the sliding member of the present embodiment, the content of the fired clay dispersed in PTFE is 8.3 wt % or more and 15.7 wt % or less, and the content of the fired clay as a hard material is larger than that in the conventional technology. It is contemplated that the hard material has an action of slightly polishing and smoothening a surface of a counter shaft by sliding, and therefore, it is contemplated that in a case where the surface of the counter shaft is rough, the surface of the counter shaft becomes smother than before sliding, and the progress of wear of the sliding member itself can be suppressed.

In addition, the sliding member of the present embodiment contains the fired clay, magnesium phosphate, barium sulfate, and molybdenum disulfide with the contents described above. Therefore, it is contemplated that a balance among low friction, wear resistance, and seizure resistance of the sliding member is adjusted, and the wear resistance can be effectively improved.

Accordingly, it is presumed that a sliding member 14 of the present embodiment can improve wear resistance.

Hereinafter, a sliding member and a sliding body according to the present embodiment will be described in detail.

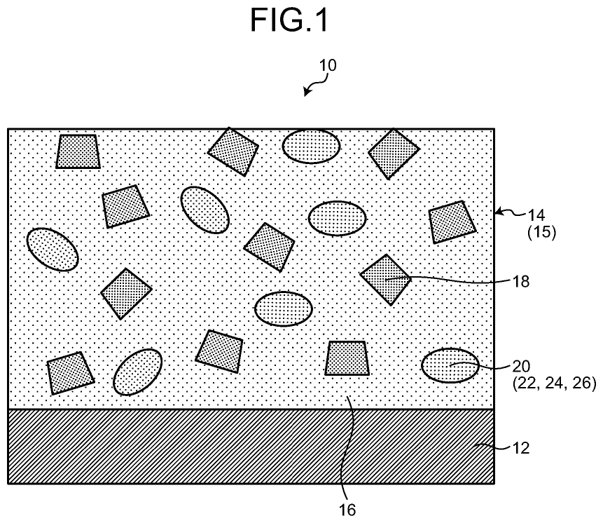

FIG. 1 is a schematic view illustrating an example of a sliding body 10 of the present embodiment. FIG. 1 schematically illustrates an example of a cross-sectional structure of the sliding body 10.

The sliding body 10 includes a base material 12 and a sliding member 14. The sliding body 10 is a laminate of the base material 12 and the sliding member 14 formed on the base material 12.

The base material 12 is a layer for providing mechanical strength to the sliding body 10. The base material 12 may be referred to as a back metal or a back metal layer. As the base material 12, for example, a metal plate such as an Fe alloy, Cu, or a Cu alloy can be used. In addition, a wire net may be used as the base material 12.

At least a partial region of the base material 12 on a bonding surface with the sliding member 14 may be constituted by a sintered layer. The sintered layer is a sintered body of a metal powder, and is a porous layer having a plurality of pores. The metal powder constituting the sintered layer may be the same metal as the base material 12, or may be a metal or a material different from the base material 12. As the metal power, for example, a mixed powder of a copper alloy such as copper tin, copper lead tin, and phosphor bronze, and a metal powder such as iron, copper, and tin may be used. Adhesion between the base material 12 and the sliding member 14 can be improved by adopting structure including the sintered layer.

In addition, at least a partial region of the base material 12 on a contact surface with the sliding member 14 may be a region subjected to a roughening treatment. For the roughening treatment, shot blasting or the like may be used.

The sliding member 14 is a resin layer 15 laminated on the base material 12.

The sliding member 14 is formed of PTFE 16, magnesium phosphate 22, barium sulfate 24, and molybdenum disulfide 26. The magnesium phosphate 22, the barium sulfate 24, and the molybdenum disulfide 26 function as a solid lubricant 20 and are dispersed in the PTFE 16. In FIG. 1, as a simplified view, the magnesium phosphate 22, the barium sulfate 24, and the molybdenum disulfide 26 are collectively illustrated as the solid lubricant 20. However, the magnesium phosphate 22, the barium sulfate 24, and the molybdenum disulfide 26 are each actually dispersed in the PTFE 16.

A content of the magnesium phosphate 22 with respect to the total amount of the sliding member 14 being 100 wt % is 2.4 wt % or more and 15.6 wt % or less, preferably 6.9 wt % or more and 12.0 wt % or less, and more preferably 6.9 wt % or more and 7.9 wt % or less.

By the sliding member 14 contains the magnesium phosphate 22 with a content within the range described above, film forming capacity of a lubricating film on a sliding surface of the sliding member 14 by the PTFE 16 can be enhanced, and the wear resistance can be improved.

An average particle size of the magnesium phosphate 22 is not limited. For example, the average particle size of the magnesium phosphate 22 is in a range of 10 μm or more and 50 μm or less.

Examples of the magnesium phosphate 22 include magnesium pyrophosphate (Mg₂P₂O₇) and magnesium metaphosphate [Mg(PO₃)₂]ₙ. Among them, magnesium metaphosphate is more preferable.

A content of the barium sulfate 24 with respect to the total amount of the sliding member 14 being 100 wt % is 7.6 wt % or more and 19.9 wt % or less and preferably 9.8 wt % or more and 12.3 wt % or less.

By the sliding member 14 containing the barium sulfate 24 with a content within the range described above, the wear resistance and load resistance of the PTFE 16 can be further improved.

An average particle size of the barium sulfate 24 is not limited. For example, the average particle size of the barium sulfate 24 is 12 μm or less, preferably 1 μm or more and 12 μm or less, and more preferably 8 μm or more and 12 μm or less.

As the barium sulfate 24, either precipitated barium sulfate or elutriated barium sulfate may be used.

A content of the molybdenum disulfide 26 with respect to the total amount of the sliding member 14 being 100 wt % is 0 wt % or more and 10.0 wt % or less and preferably 4.7 wt % or more and 7.9 wt % or less.

By the sliding member 14 containing the molybdenum disulfide 26 with a content within the range described above, the lubricity of the PTFE 16 can be improved, and the wear resistance of the sliding member 14 can be improved.

An average particle size of the molybdenum disulfide 26 is not limited. For example, the average particle size of the molybdenum disulfide 26 is 0.5 μm or more and 2.5 μm or less, preferably 0.5 μm or more and 2.0 μm or less, and more preferably 1.0 μm or more and 2.0 μm or less.

A content of the fired clay 18 with respect to the total amount of the sliding member 14 being 100 wt % is 8.3 wt % or more and 15.7 wt % or less and preferably 8.7 wt % or more and 11.0 wt % or less.

By the sliding member 14 containing the fired clay 18 with a content within the range described above, the hard material slightly polishes and smoothens the surface of the counter shaft during sliding even in a case where the surface of the counter member such as a shaft member is rough, so that the progress of wear of the sliding member itself can be suppressed. Therefore, the wear resistance of the sliding member 14 can be improved.

In addition, the fired clay 18 is obtained by subjecting the clay to a high heat treatment. By the high heat treatment, the fired clay 18 is activated and becomes porous to be a material having excellent oil absorptiveness. Therefore, by the sliding member 14 containing the fired clay 18, the wettability of the sliding surface of the sliding member 14 with oil can be improved by an oil absorbing effect of the fired clay 18. When the wettability of the sliding surface of the sliding member 14 with oil is improved, a lubricating oil film is likely to be formed on the sliding surface of the sliding member 14 under grease lubrication and in oil, the low friction of the sliding member 14 can be improved, and the wear resistance can be improved.

An average particle size of the fired clay 18 is not limited. For example, the average particle size of the fired clay 18 is preferably 0.5 μm or more and 10 μm or less, more preferably 1.0 μm or more and 8.0 μm or less, and particularly preferably 1.5 μm or more and 6.0 μm or less.

The average particle sizes of the fired clay 18 and the solid lubricant 20 may be measured by the following method. Specifically, for example, an electron image obtained by imaging a cross section of the sliding member 14 at an appropriate magnification (for example, 1,000 times) using an electron microscope is obtained. Then, an area of the fired clay 18 or the solid lubricant 20 included in the obtained electron image is measured by a general image analysis method, and is converted into an average diameter in a case where the area is assumed to be a circle. The average particle sizes of the fired clay 18 and the solid lubricant 20 may be determined by these treatments.

Examples of the fired clay 18 include fired kaolin. The fired kaolin is obtained by subjecting kaolin, which is a natural clay mineral, to a high-temperature treatment.

As the PTFE 16 as a main component of the resin layer 15, for example, PTFE mainly used for molding as a molding powder or fine powder may be used.

Examples of the PTFE for the molding powder include “Teflon (registered trademark) 7-J (trade name)” and “Teflon (registered trademark) 70-J (trade name)” manufactured by Dupont-Mitsui Fluorochemicals Co., Ltd., “Polyflon M-12 (trade name)” manufactured by Daikin Industries, Ltd., and “Fluon G163 (trade name)” and “Fluon G190 (trade name)” manufactured by Asahi Glass Co., Ltd. Examples of the PTFE for the fine powder include “Teflon (registered trademark) 6CJ (trade name)” manufactured by Dupont-Mitsui Fluorochemicals Co., Ltd., “Polyflon F201 (trade name)” manufactured by Daikin Industries, Ltd., and “Fluon CD076 (trade name)” and “Fluon CD090 (trade name)” manufactured by Asahi Glass Co., Ltd.

A content of the PTFE 16 in the sliding member 14 may be the remaining amount after subtracting the total amount of the solid lubricant 20 such as the magnesium phosphate 22, the barium sulfate 24, and the molybdenum disulfide 26 and the additional components such as the filler from the total amount of the sliding member 14.

For example, the content of the PTFE 16 in the sliding member 14 is 40 wt % or more and 95 wt % or less, preferably 45 wt % or more and 80 wt % or less, and more preferably 50 wt % or more and 65 wt % or less, with respect to the total amount of the sliding member 14 being 100 wt %.

Note that the sliding member 14 of the present embodiment may have composition further containing additional components from the viewpoint of further improving the wear resistance. However, it is preferable that the sliding member 14 does not contain a silicate. This is because the silicate is soft and thus may deteriorate the wear resistance.

Examples of the additional components include at least one type of filler selected from spherical carbon, glass spheres, carbon fibers, graphite fibers, glass fibers, resin powders, resin fibers, metal powders, and metal fibers.

A content of the filler in the sliding member 14 is preferably 10 wt % or less with respect to the total amount of the sliding member 14 being 100 wt %.

By the sliding member 14 containing the filler, the strength and wear resistance of the sliding member 14 can be improved.

(Method of Producing Sliding Body)

The sliding body 10 of the present embodiment is produced by, for example, the following processes.

A resin material layer is formed on the base material 12 by applying a raw material mixture containing constituent materials of the sliding member 14 having the composition described above onto the base material 12. As application conditions, known conditions may be used. For example, as a method of applying the raw material mixture, spray, tumbling, roll transfer, printing, or the like may be used.

Note that the resin material layer may be formed on the base material 12 by impregnating the roughened base material 12 or the base material 12 having the sintered layer formed, with the raw material mixture. A thickness of the sintered layer is, for example, 0.1 mm or more and 0.3 mm or less.

Then, the resin material layer applied onto the base material 12 is fired. As firing conditions, known conditions may be used. For example, the resin material layer is fired by holding the resin material layer at 350° C. to 450° C. By the firing treatment, the sliding member 14 is formed on the base material 12. A thickness of the sliding member 14 formed on the base material 12 is not limited. The thickness of the sliding member 14 is, for example, 10 μm or more and 60 μm or less and preferably 20 μm or more and 40 μm or less.

(Action of Sliding Body)

Next, an example of an action of the sliding member 14 of the present embodiment will be described.

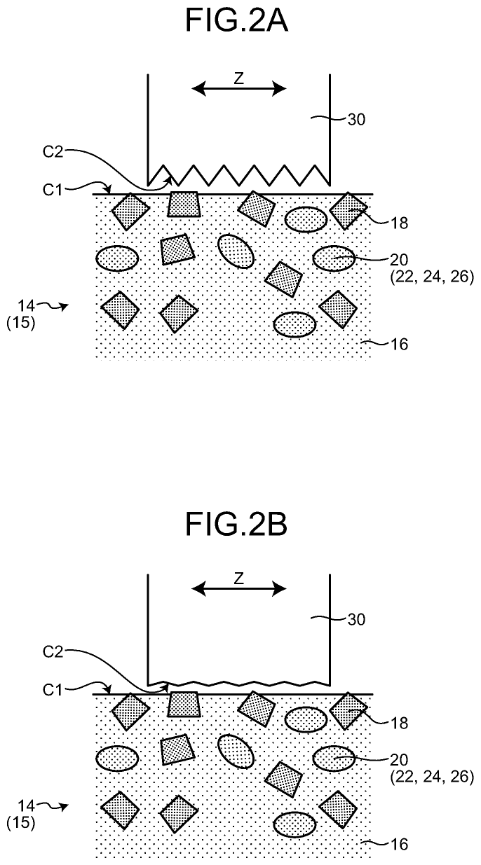

FIGS. 2A and 2B are explanatory views of an example of the action of the sliding member 14.

As described above, the sliding member 14 of the present embodiment is formed of the PTFE 16 containing 2.4 wt % or more and 15.6 wt % or less magnesium phosphate, 7.6 wt % or more and 19.9 wt % or less barium sulfate, 0 wt % or more and 10.0 wt % or less molybdenum disulfide, and 8.3 wt % or more and 15.7 wt % or less fired clay.

In the sliding member 14 of the present embodiment, the content of the fired clay 18 dispersed in the PTFE 16 is 8.3 wt % or more and 15.7 wt % or less, and the content of the fired clay 18 as a hard material is larger than that in the conventional technology. Therefore, it is contemplated that even in a case where a surface of a counter member such as a shaft member 30 is rough, the hard material slightly polishes and smoothens the surface of the counter shaft during sliding, so that the progress of wear of the sliding member 14 itself can be suppressed.

Specifically, as illustrated in FIG. 2A, it is assumed that a surface roughness of a sliding surface C2 of the shaft member 30 with the sliding member 14 is rough. The surface roughness of the sliding surface C2 of the shaft member 30 is rough means that the sliding surface C2 of the shaft member 30 has a roughness equal to or more than a roughness that causes a sliding surface C1 of the resin layer formed of the PTFE 16 not containing the fired clay 18 and the solid lubricant 20 to be worn by a predetermined amount or more by sliding. The surface roughness of the sliding surface C2 of the shaft member 30 is rough specifically means that a surface roughness Ra of the sliding surface C2 of the shaft member 30 is, for example, in a range of 0.3 or more and 0.7 or less.

Here, a comparative sliding member is assumed in which the content of the fired clay 18 dispersed in the PTFE 16 of the sliding member 14 does not satisfy the content of the fired clay 18 of the present embodiment described above. In this case, the amount of wear of a sliding surface of the comparative sliding member with the shaft member 30 due to the rough sliding surface C2 of the shaft member 30 is large, and wear resistance may not be obtained.

On the other hand, in the sliding member 14 of the present embodiment, the content of the fired clay 18 dispersed in the PTFE 16 is 8.3 wt % or more and 15.7 wt % or less, and the content of the fired clay 18 as a hard material is larger than that in the conventional technology. Therefore, it is contemplated that even in a case where the surface of the counter member such as the shaft member 30 is rough, the fired clay 18 slightly polishes the rough surface of the sliding surface C2 of the counter member to smoothen the sliding surface C2 of the shaft member 30 when the sliding member 14 slides (see FIG. 2B). Therefore, it is contemplated that the sliding member 14 of the present embodiment can suppress the amount of wear of the sliding member 14 itself.

In addition, the sliding member 14 of the present embodiment contains the fired clay 18, the magnesium phosphate 22, the barium sulfate 24, and the molybdenum disulfide 26 with the contents described above. Therefore, it is contemplated that a balance among low friction, wear resistance, and seizure resistance of the sliding member 14 is adjusted, and the wear resistance can be effectively improved.

Accordingly, it is presumed that the sliding member 14 and the sliding body 10 including the sliding member 14 of the present embodiment can improve wear resistance.

(Application Form)

Next, an example of a form of applying the sliding body 10 will be described.

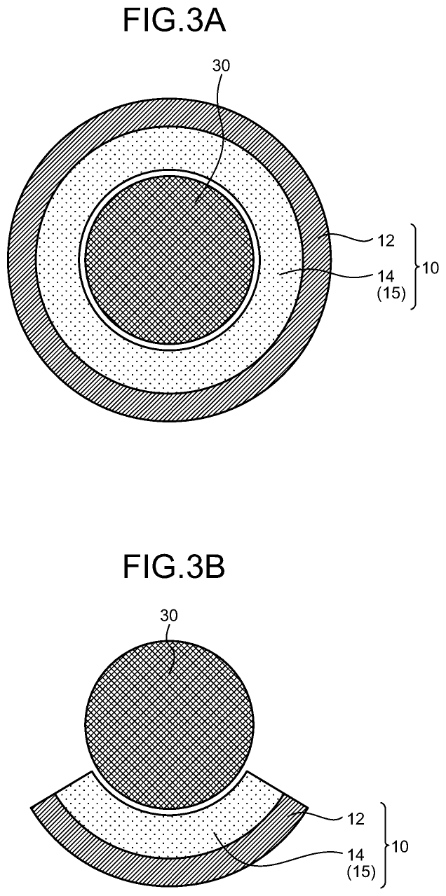

FIGS. 3A and 3B are schematic views illustrating examples of the form of applying the sliding body 10. The sliding body 10 is applied to, for example, a bushing for a shift fork of a manual transmission as illustrated in FIG. 3A.

As illustrated in FIG. 3B, the sliding body 10 is used in a steering mechanism in a vehicle such as an automobile, has a low sliding speed, and is used in grease lubrication. For example, it is applied to an arc-shaped bearing used for a support yoke portion attached to a rack and pinion power steering, and low friction and wear resistance are considered as important. Therefore, it is possible to effectively improve wear resistance of a sliding bearing by applying the sliding body 10 of the present embodiment.

Specifically, for example, a sliding device includes the shaft member 30 and the sliding body 10. The shaft member 30 is a columnar member and functions as a shaft. The sliding body 10 has, for example, an annular shape or an arc shape in which the sliding member 14 is disposed on an inner peripheral surface of the base material 12, and the shaft member 30 is disposed inside. That is, the sliding body 10 functions as, for example, a bushing (FIG. 3A) or an arc-shaped bearing (FIG. 3B).

Note that the sliding device is not limited to the form illustrated in FIGS. 3A and 3B. For example, the shaft member 30 and the sliding body 10 may have a flat plate shape.

### EXAMPLES

Hereinafter, the present invention will be specifically described with reference to Examples, but the present invention is not limited to these Examples.

The following sliding body 10 and the comparative sliding body were produced, and the wear resistance was evaluated.

### Example 1

—Adjustment of Base Material 12—

A back metal steel plate (SPCC (JIS)) having a thickness of 1.5 mm was prepared. A surface of the back metal steel plate was subjected to a sanding treatment, and then a phosphor bronze powder was sprayed on the degreased back metal steel plate. Then, the dispersed phosphor bronze powder was sintered at 920° C. to 950° C. to adjust a base material 12 on which a sintered layer having a thickness of 0.1 mm to 0.3 mm was formed on the back metal steel plate.

—Adjustment of Sliding Member (Resin Layer)—

As a raw material mixture formed of constituent materials of a sliding member 14, a raw material mixture having the composition shown in Example 1 of Table 1 was adjusted. Then, a resin material layer was formed by impregnating and coating the adjusted raw material mixture on the sintered layer of the base material 12 with a roll. Then, the resin material layer was fired at 350° C. to 420° C. to form the sliding member 14 of Example 1 on the base material 12. A thickness of the formed sliding member 14 was 0.01 mm to 0.06 mm. By these treatments, a sliding body 10 of Example 1 was produced.

### Examples 2 to 14 and Comparative Examples 1 to 7

Sliding bodies 10 of Examples 2 to 14 and comparative sliding bodies of Comparative Examples 1 to 7 were produced in the same manner as that of Example 1, except that raw material mixtures having the compositions of Examples 2 to 14 and Comparative Examples 1 to 7 shown in Table 1 were adjusted as the raw material mixtures formed of the constituent materials of the sliding member 14.

TABLE 1

| | | | | | | Evaluation |
|---|---|---|---|---|---|---|
| | Sliding member composition contents [wt %] | | | | | Amount of |
| | | Magnesium | Barium | Molybdenum | | wear |
| | PTFE | phosphate | sulfate | disulfide | Fired clay | [μm] |
| Example 1 | Remainder | 6.9 | 9.8 | 4.7 | 8.7 | 16.5 |
| Example 2 | Remainder | 7.4 | 11.1 | 6.3 | 9.9 | 14.3 |
| Example 3 | Remainder | 7.9 | 12.3 | 7.9 | 11.0 | 16.5 |
| Example 4 | Remainder | 12.0 | 10.0 | 4.5 | 11.0 | 15.3 |
| Example 5 | Remainder | 12.0 | 10.0 | 4.5 | 11.0 | 14.5 |
| Example 6 | Remainder | 15.6 | 7.8 | 0.0 | 15.7 | 14.8 |
| Example 7 | Remainder | 2.6 | 19.9 | 0.0 | 14.6 | 14.5 |
| Example 8 | Remainder | 13.8 | 18.9 | 9.6 | 13.9 | 16.0 |
| Example 9 | Remainder | 2.4 | 18.8 | 9.6 | 13.8 | 15.5 |
| Example 10 | Remainder | 2.6 | 13.8 | 5.2 | 8.5 | 15.0 |
| Example 11 | Remainder | 9.0 | 7.6 | 5.3 | 8.8 | 14.3 |
| Example 12 | Remainder | 8.7 | 13.8 | 5.2 | 8.5 | 16.3 |
| Example 13 | Remainder | 9.0 | 14.2 | 0.0 | 8.8 | 14.5 |
| Example 14 | Remainder | 8.4 | 13.4 | 10.0 | 8.3 | 14.8 |
| Comparative | Remainder | 13.7 | 17.3 | 5.1 | 2.5 | 20.5 |
| Example 1 | | | | | | |
| Comparative | Remainder | 13.7 | 17.3 | 5.1 | 2.5 | 20.8 |
| Example 2 | | | | | | |
| Comparative | Remainder | 13.7 | 17.3 | 5.1 | 2.5 | 22.0 |
| Example 3 | | | | | | |
| Comparative | Remainder | 2.6 | 7.4 | 10.5 | 2.2 | 34.0 |
| Example 4 | | | | | | |
| Comparative | Remainder | 16.0 | 7.9 | 0.0 | 2.3 | 23.5 |
| Example 5 | | | | | | |
| Comparative | Remainder | 2.6 | 20.3 | 0.0 | 2.1 | 34.0 |
| Example 6 | | | | | | |
| Comparative | Remainder | 8.8 | 13.9 | 5.2 | 2.1 | 23.3 |
| Example 7 | | | | | | |

—Evaluation—

—Wear Resistance—

For each of the sliding bodies 10 of Examples 1 to 14 and the comparative sliding bodies of Comparative Examples 1 to 7, the wear resistance of the sliding member 14 and the comparative sliding member was evaluated.

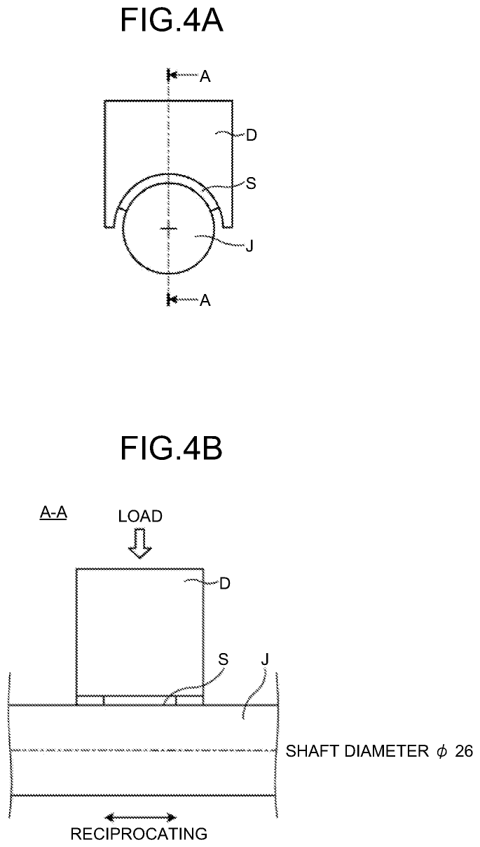

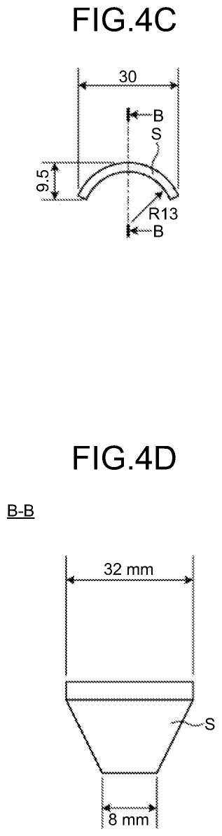

FIGS. 4A to 4D are explanatory views of an evaluation test of wear resistance.

In the wear resistance test, a sample S was attached to a pedestal D, and a shaft J was reciprocated and slid with respect to the sample S in a state where a load I was applied to the pedestal D.

The shaft J is an example of a shaft member 30 and corresponds to a counter member that slides. The sample S corresponds to each of the sliding bodies 10 of Examples 1 to 14 and the comparative sliding bodies of Comparative Examples 1 to 7. As the sample S, a sample obtained by molding each of the sliding body 10 and the comparative sliding body in an arc plate shape is used, and the sample S is attached to the pedestal so that sliding surfaces C1 of the sliding member 14 and the comparative sliding member face the shaft J.

FIG. 4A is a schematic view of the state of the wear resistance evaluation test as viewed from a direction along an extending direction of the shaft J. FIG. 4B is a cross-sectional view taken along line A-A of FIG. 4A. FIG. 4C is a schematic view illustrating the shape of the sample S. As illustrated in FIG. 4C, the sample S had an arc plate shape with a radius of R13 mm, a height of 9.5 mm, a length in an arc direction of 30 mm, and a length in an axial direction of 32 mm. FIG. 4D is a cross-sectional view taken along line B-B of FIG. 4C.

As illustrated in FIGS. 4A to 4D, the sample S was attached to the pedestal D, and a load was applied to the pedestal D to press the sample S against the peripheral portion of the shaft J having a shaft diameter Φ of 26 mm. Then, the wear resistance test was performed by reciprocating and sliding the shaft J in the axial direction of the extension direction of the shaft J (the left-right direction in FIGS. 4A to 4D). The test conditions for the wear resistance test were as follows.

Test Conditions of Wear Resistance Test
Stroke of reciprocation of shaft J: 20 mm
Sliding speed: 55 mm/s
Evaluation time: 3 hours
Load: 3,500 N
Load form: static load
Oil temperature: normal temperature
Oil supply method: application of grease
Oil type: Molywhite LSG manufactured by Kyodo Yushi Co., Ltd.
Material of shaft J: S45C
Hardness of shaft J: HRC 24 to 30
Surface roughness Ra of shaft J: 0.3 to 0.7

Then, for each of the samples S of the sliding bodies 10 of Examples 1 to 14 and the comparative sliding bodies of Comparative Examples 1 to 7, the wear resistance test was performed under the test conditions, and the amount of wear of the sample S was evaluated. The evaluation results are shown in Table 1.

As shown in Table 1, in the sliding bodies 10 of Examples 1 to 14, the amount of wear was reduced as compared with the comparative sliding bodies of Comparative Examples 1 to 7. Therefore, the sliding bodies 10 of Examples 1 to 14 were evaluated to have improved wear resistance as compared with the comparative sliding bodies of Comparative Examples 1 to 7.

Note that various materials and compositions thereof used in Examples described above are merely examples, and the present invention is not limited thereto. The sliding member 14 according to the present invention may further contain inevitable impurities and the like. In addition, specific structures of the sliding member 14 and the sliding body 10 are not limited to those exemplified in FIGS. 1 to 3B.

What is claimed is:

1. A sliding member formed of a polytetrafluoroethylene resin, wherein the polytetrafluoroethylene resin contains:
2.4 wt % or more and 15.6 wt % or less magnesium phosphate,
7.6 wt % or more and 19.9 wt % or less barium sulfate,
0 wt % or more and 10.0 wt % or less molybdenum disulfide, and
8.3 wt % or more and 15.7 wt % or less fired clay.

2. The sliding member according to claim 1, wherein a silicate is not contained.

3. The sliding member according to claim 1, wherein the polytetrafluoroethylene resin further contains at least one type of filler selected from spherical carbon, a glass sphere, a carbon fiber, a graphite fiber, a glass fiber, a resin powder, a resin fiber, a metal powder, and a metal fiber in a total filling amount of 10 wt % or less.

4. A sliding body comprising:
a base material; and
the sliding member according to claim 1 provided on the base material.
